(19) United States
(12) Patent Application Publication
(10) Pub. No.: US 2014/0308245 A1
(43) Pub. Date: Oct. 16, 2014

(54) PEST CONTROL COMPOSITION AND METHOD FOR PREPARING SAME

(71) Applicant: Seung Mok KIM, Dobong-gu Seoul (KR)

(72) Inventor: Seung Mok Kim, Seoul (KR)

(21) Appl. No.: 14/362,914

(22) PCT Filed: Dec. 7, 2012
(86) PCT No.: PCT/KR2012/010641

§ 371 Date: Jun. 5, 2014

(30) Foreign Application Priority Data
Dec. 9, 2011 (KR) 10-2011-0132007

(51) Int. Cl. A01N 63/00; A01N 65/08

(52) U.S. Cl. CPC A01N 63/00; A01N 65/08
USPC 424/93.1

(57) ABSTRACT

Disclosed are a pest control composition which comprises extracts of used coffee grounds, yolk oil, and an EM activated solution as active ingredients, and a method for preparing a pest control composition which comprises (A) preparing an extract of coffee grounds by heating coffee grounds in boiling water for 5 minutes or more so that coffee oil is sufficiently extracted in the boiling water; (B) diluting the extract of coffee grounds with water; (C) preparing egg yolk oil by mixing egg yolk and edible oil; and (D) mixing an EM activated solution with the extract of coffee grounds of Operation (A) and the egg yolk oil of Operation (C).

### TECHNICAL FIELD

The present invention relates to a plant pest control composition including an extract of coffee grounds as an active ingredient.

### BACKGROUND ART

In recent years, coffee-drinking culture has become universal, and shops selling coffee including cafés are increasing in response to this trend. Therefore, coffee beans are being increasingly used, and thus coffee grounds remaining after extraction of coffee are increasing. Since such coffee grounds are not recycled as food waste, the coffee grounds should be disposed of as general waste, resulting in an increase in waste disposal costs. However, when coffee grounds are thoroughly dried, they can be used as an effective air freshener and dehumidifying agent. In particular, when coffee grounds are used to deodorize refrigerators, closets, shoe shelves and the like, and clean dishes, refrigerators, sinks, microwave ovens and the like, many unpleasant smells can be removed and the articles can be cleaned. When coffee grounds are put in flowerpots, it is possible to maintain a proper level of humidity and provide nutrients. Further, coffee grounds are effectively used in many different fields such as removal of keratin cells from skin, deodorization of the greasy smell of pork, and the like. Although these effects of coffee grounds have been known and are sometimes used in general homes, it is still difficult to recover and recycle all coffee grounds which are discarded in large quantities. In particular, cafés have distributed coffee grounds to citizens for free, but the coffee grounds are recycled at a very low level compared to the total quantity of discarded coffee grounds.

Meanwhile, plans for using coffee grounds in agriculture may be considered, and it is known that the coffee grounds can be used as culture soil in flowerpots or used to maintain humidity and provide nutrients. However, when coffee grounds are used to control insects and pests in addition to other agricultural uses, it is possible to reduce the amount of agricultural pesticides which are harmful to humans, thereby improving the quality of agriculture, reducing production costs, and recycling resources.

### DISCLOSURE

### Technical Problem

Therefore, the present invention is designed to solve the problems of the prior art, and therefore it is an object of the present invention to provide a pest control composition using coffee grounds. Also, it is another object of the present invention to provide a method for preparing a pest control composition.

### Technical Solution

According to an aspect of the present invention, there is provided a pest control composition including an extract of coffee grounds, egg yolk oil and an effective microorganism (EM) activated solution as active ingredients.

In the composition, the extract of coffee grounds is characterized in that it is present at a content of 85 to 95 parts by weight, based on a total of 100 parts by weight of the composition. In general, an undiluted solution of coffee has a pH value of pH 4 to 5, and water-soluble coffee oil has a pH value of pH 6 or more. Thus, since coffee itself shows high acidity, it is difficult to adjust the concentration of the coffee. As a result, when the coffee grounds are directly sprayed on trees or crops, the trees or crops may wither. In the case of lettuce, chili peppers, perilla, and potatoes, the leaves may turn yellowish. Due to such acidity-related problems, the coffee grounds may cause damage to the crops when an excessive amount of the coffee grounds is sprayed onto the soil. To solve these problems, coffee oil is sufficiently extracted from the coffee grounds, and the concentration of the extract is adjusted, thereby preventing pests and simultaneously avoiding the damage of the crops.

The egg yolk oil is a mixture including egg yolk and vegetable oil as main ingredients, and is characterized in that it is present at a content of 4 to 10 parts by weight, based on a total of 100 parts by weight of the composition. Also, mayonnaise may be used instead of the egg yolk for preparation of the egg yolk oil. Since mayonnaise is already prepared by mixing egg yolk and edible oil, a mayonnaise mixed solution may be prepared by mixing mayonnaise with water, followed by mixing with a small amount of edible oil. Therefore, according to one exemplary embodiment of the present invention, the egg yolk oil refers to a mixture including egg yolk and vegetable oil as main ingredients. In this case, the mayonnaise mixed solution may be used instead of the egg yolk oil. When the mayonnaise mixed solution is used instead of the egg yolk oil, the cost of production may be reduced, compared with typical egg yolk oils.

Then, the EM activated solution is characterized in that it is present at a content of 1 to 5 parts by weight, based on a total of 100 parts by weight of the composition.

The present invention provides a method for preparing a plant pest control composition, characterized in that the method includes:
(A) preparing an extract of coffee grounds by heating coffee grounds in boiling water so that coffee oil can be sufficiently extracted in the boiling water;
(B) diluting the extract of coffee grounds with water;
(C) preparing egg yolk oil by mixing egg yolk and edible oil; and
(D) mixing an EM activated solution with the extract of coffee grounds of Operation (A) and the egg yolk oil of Operation (C).

### Advantageous Effects

The composition according to one exemplary embodiment of the present invention has an effect of preventing damage of plants from pests such as mole crickets, diamondback moth larvae, and the like since coffee oil constituents and tannin components extracted from the coffee grounds, egg yolk oil, and an EM mixture act in connection with the composition. Also, since the effects of the coffee grounds last for approximately one to two weeks after spraying the coffee grounds once, the coffee grounds need not be scattered around the plants often, and eco-friendly plants can grow without using ingredients of agricultural chemicals since the coffee grounds are harmless to the plants.

Also, the mixture of egg yolk oil and an EM activated solution may act on the leaves to continuously provide a pest repellent effect.

Further, since the plant pest control composition according to one exemplary embodiment of the present invention uses the coffee grounds discarded as waste, the composition has an advantage in that the production cost is very low, and the active ingredients, for example, coffee, eggs, edible oil and mayonnaise, are foods or favorite which humans can eat, and thus have a little or no toxicity to humans. Also, since the EM activated solution has already been widely used in eco-friendly fields, the EM activated solution is harmless to humans and also serves to prevent pests from accessing crops to which the pests can cause damage.

### DESCRIPTION OF DRAWINGS

FIG. 1 shows images of young radish leaves for comparison when coffee grounds are sprayed around young radishes.

FIG. 2 shows images of maize for comparison before and after an unboiled solution of coffee grounds is sprinkled on maize seedlings.

FIG. 3 shows an image of lettuce, Chinese cabbage and white radishes after a boiled solution of coffee grounds is sprinkled on the lettuce, Chinese cabbage and white radishes.

FIG. 4 shows images of crops for comparison before and after a plant pest control composition according to one exemplary embodiment of the present invention is sprayed on the crops.

FIG. 5 shows images of lettuce, white radishes and Chinese cabbage for comparison before and after the plant pest control composition according to one exemplary embodiment of the present invention is sprayed on the lettuce, white radishes and Chinese cabbage.

### BEST MODE

Hereinafter, preferred embodiments of the present invention will be described in further detail.

In the present invention, since the active ingredients, for example, coffee, eggs and edible oil, are foods or favorite foods which humans can eat, the active ingredients have little or no toxicity to humans. Also, since the EM activated solution has already been widely used in eco-friendly fields, the EM activated solution is harmless to humans and also serves to prevent pests from accessing crops to which the pests can cause damage.

For the pest control composition according to one exemplary embodiment of the present invention, 60 cc of coffee grounds, one egg yolk, 160 ml of edible oil, and 40 ml of an EM activated solution were prepared as the main ingredients.

1. Preparation and Dilution of Extract of Coffee Grounds

First, 60 cc of coffee grounds was put into 200 ml of boiling water, and heated for 5 minutes until a sufficient amount of coffee oil was extracted from the coffee grounds. This is to maximize an effect of extracting soluble components from the coffee grounds. In general, chlorogenic acid that is a kind of polyphenol included in coffee is decomposed into quinic acid and caffeic acid by time and with heat. In this case, caffeic acid is a component giving coffee a bitter taste. As a result, when the extraction was performed for 5 minutes or more, chlorogenic acid and phenol compounds were increasingly produced, resulting in strong bitter and astringent tastes. In the case of dark roast coffee, since the coffee has a large amount of soluble components, chlorogenic acid and phenol compounds are increasingly produced when the coffee is extracted in cold water for an extraction time of 5 minutes or more, which results in strong bitter and astringent tastes. The coffee grounds refer to dregs remaining after extraction of coffee, and encompass all kinds of coffee beans. Coffee beans include moisture, ash, fats, crude fibers, crude sugars, crude proteins, caffeine, and the like. The contents of the respective components vary according to the varieties and growing conditions, but the crude sugars amount for the highest percentage (i.e., 30%). When heat is applied to the crude sugars, the crude sugars are converted into caramel which turns coffee-colored. The fats are components which are most associated with coffee flavor, and amount to 12 to 16%. The caffeine and capeline amount to approximately 1.3%, and thus serve to influence the coffee flavor and have a stimulant action. Caffetanic acid gives a distinctive bitter taste, and amounts to 3 to 5%.

When water turned brown after a fat component, coffee oil, was sufficiently extracted from the coffee grounds, the coffee grounds were filtered through a fine sieve, and discarded. Then, the filtered solution was added to 1,800 ml of water, to dilute the extract of coffee grounds. As a result, a total of 2 L of a coffee solution was prepared.

An EM solution was mixed with an extract of coffee grounds prepared by mixing water and coffee grounds at a volume ratio of 1:1 and boiling the mixture. Then, the resulting mixture was sprayed on small insects sucking sap from a maple tree. As a result, the mixture not only had a pest repellent effect but also killed the insects, but it was found that the mixture had a side-effect of turning the leaves of the maple tree brown.

Therefore, since the coffee grounds showed such a side-effect when the coffee grounds were boiled for 5 minutes or more, the concentrations of the active components should be necessarily adjusted upon preparation of a pest repellent composition. Such concentration adjustment is required to cut the cost of production and also prevent damage to crops.

In the composition according to one exemplary embodiment of the present invention, the extract of coffee grounds was preferably present at a content of 85 to 95 parts by weight, based on a total of 100 parts by weight of the composition. When the content of the extract of coffee grounds was outside of this content range, a pest repellent effect was poor, or did not last for a long period of time.

2. Preparation of Egg Yolk Oil

Meanwhile, an egg yolk and 160 cc of edible oil were thoroughly mixed in a mixer to prepare 160 ml of egg yolk oil. In this case, the edible oil may be used without limitation as long as it is a vegetable oil such as soybean oil, corn oil, canola oil, rapeseed oil, or sunflower oil.

The egg yolk evenly contains almost all kinds of nutrients, and thus serves as a nutritional supplement, and aids in breaking the edible oil into fine oil drops when the edible oil is strongly mixed in a mixer. The finer oil drops are more readily dispersed and deposited and show a more excellent pest repellent effect.

When the egg yolk oil is often used or the edible oil is added at a large content, the oil clogs the stomata of the crops, resulting in suppressed growth of the crops and increased necrosis of the tissues. Accordingly, the content of the egg yolk oil or edible oil should be adjusted so that the content of the egg yolk oil or edible oil does not exceed 4 to 10 parts by weight, based on a total of 100 parts by weight of the composition.

Meanwhile, a mayonnaise mixed solution that includes mayonnaise, which is prepared by mixing egg yolk and oil, may be used instead of the egg yolk oil. In this case, 15 ml of mayonnaise is added to 2 L of water, and thoroughly mixed in a mixer. Thereafter, 5 ml of conventional edible oil is added to the resulting mixture to prepare 2020 ml of a final mayonnaise mixed solution. In this case, the edible oil may be used without limitation as long as it is a vegetable oil such as soybean oil, corn oil, canola oil, rapeseed oil, or sunflower oil. The mayonnaise mixed solution serves as a nutritional supplement since it contains the nutritional components of the egg yolk. Also, since the edible oil is strongly mixed in a mixer for a long period of time, the edible oil is broken into fine oil drops. The finer oil drops are more readily dispersed and deposited and show a more excellent pest repellent effect.

3. Mixing of EM Activated Solution and Preparation of Plant Pest Control Composition

40 ml of an EM activated solution was mixed with the coffee solution and egg yolk oil prepared thus. The term “EM” refers to a composite word of the terms “effective” and “microorganism” and the term “EM technology” refers to an effective microorganisms technology, which is one of technologies using microorganisms. In general, about eighty microorganisms including yeasts, lactobacilli, Aspergillus sp., photosynthetic bacteria, Actinobacteria, and the like have been used herein, and the microorganisms prepared by this technology are effective in removing bad smells, purifying the quality of water, preventing the oxidation of metals and foods, fermenting residual foods, and the like. The EM activated solution includes effective microorganisms showing excellent antioxidant, regenerative and purifying activities, which are prepared by culturing approximately 80 microorganisms which are beneficial to humans and environments, and may be diluted for use in homes. In the present invention, when the EM activated solution is mixed with the coffee solution, the EM activated solution has an effect of delaying oxidation of the tannin components and oil constituents of coffee by sunlight and wind.

In particular, the oil constituents may be easily oxidized when exposed to high temperature and air for a long period of time. Here, since vegetables and fruits are exposed to the outside in the strong summer sun, the coffee oil components in the composition including the extract of coffee grounds to be sprayed on the vegetables and fruits are easily oxidized at a high temperature. Accordingly, the extract of coffee grounds is mixed with the EM activated solution in order to prevent oxidation of the egg yolk oil and the oil constituent in the extract of coffee grounds according to one exemplary embodiment of the present invention.

Further, the EM activated solution is characterized in that it is present at a content of 1 to 5 parts by weight, based on a total of 100 parts by weight of the composition. The EM activated solution is added to prevent the oxidation of the coffee oil components, thereby continuously providing a pest control effect of the composition according to one exemplary embodiment of the present invention. Therefore, the EM activated solution may be added at a minimum quantity such that the composition can show the pest control effect.

4. Examples

A composition including the extract of coffee grounds, the egg yolk oil and the EM activated solution was prepared as described above, and sprayed on Chinese cabbage. When the leaves of Chinese cabbage (a left panel) on which the composition was not sprayed were compared with those of the Chinese cabbage (a right panel) on which the composition was sprayed a week later, it could be seen that the damage of the crops by mole crickets and diamondback moth larvae was not observed in the Chinese cabbage on which the composition was sprayed.

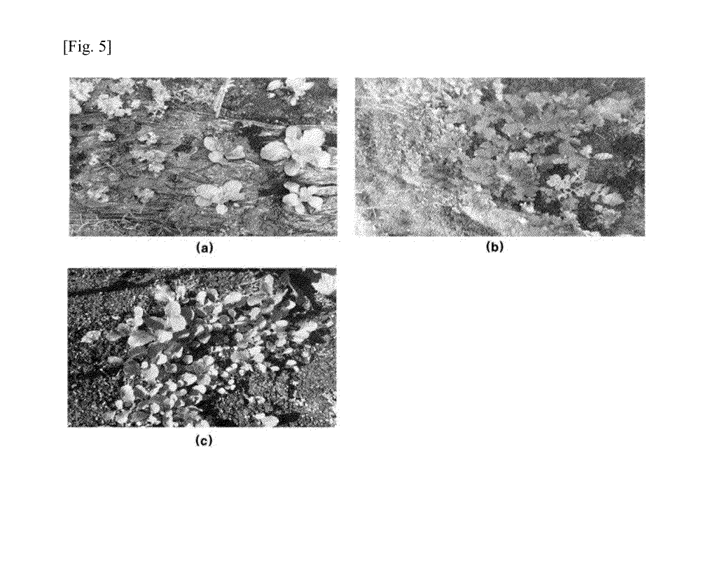

As shown in FIG. 5, it could also be seen that the composition protected the crops from harmful insects without causing damage to these crops a week later when the composition was sprayed on the seedlings of lettuce (a), white radishes (b), and Chinese cabbage (c).

Meanwhile, a category of pests against which the composition according to one exemplary embodiment of the present invention acts encompasses all kinds of pests that eat leaves. Generally, pests do not eat the leaves of persimmon trees, ginkgo trees, and dandelions, which are eaten by humans and taste bitter, and the most serious damage is caused in crops such as young radishes and especially Chinese cabbage, which taste sweet to humans. In particular, when the composition may be used to eradicate a diamondback moth which is not easily killed by pesticides and is strongly resistant to chemicals, it is possible to control the pests such as other kinds of cabbage worms, for example, pests such as Altica oleracea, cabbage white butterfly larvae, and mole crickets. Therefore, the composition according to one exemplary embodiment of the present invention may be used to control all kinds of pests since the composition makes the crops taste stringent and bitter so that the kinds of pests that eat the above-described crops and all kinds of pests that eat the leaves stayed away from the crops.
1) Chinese cabbage: diamondback moths, Altica oleracea, cabbage white butterflies, aphids, cabbage white butterfly larvae, beet armyworms, sand flies, mole crickets
2) White radishes: Altica oleracea, aphids
3) Sweet potatoes: sand flies, Gelechiidae, cicada larvae
4) Potatoes: Ancylopus pictus, click beetles, Henosepilachna vigintioctomaculata, potato tuber moths.
5) Hibiscus syriacus: aphids
6) Crown daisies, lettuce, chives, romaine lettuce: viral diseases, (not applicable).
7) Perilla: aphids
8) Maize: smut, Ostrinia furnacalis, Hyphantria cunea Drury, Mythimna separata
9) Roses: aphids, sand flies
10) Sycamore: pine caterpillars
11) Chili peppers: viral diseases, (not applicable).
12) Beans: Leguminivora glycinivorella, nematodes

5. Experimental Examples

(1) Experimental Example 1: Spraying of Coffee Grounds

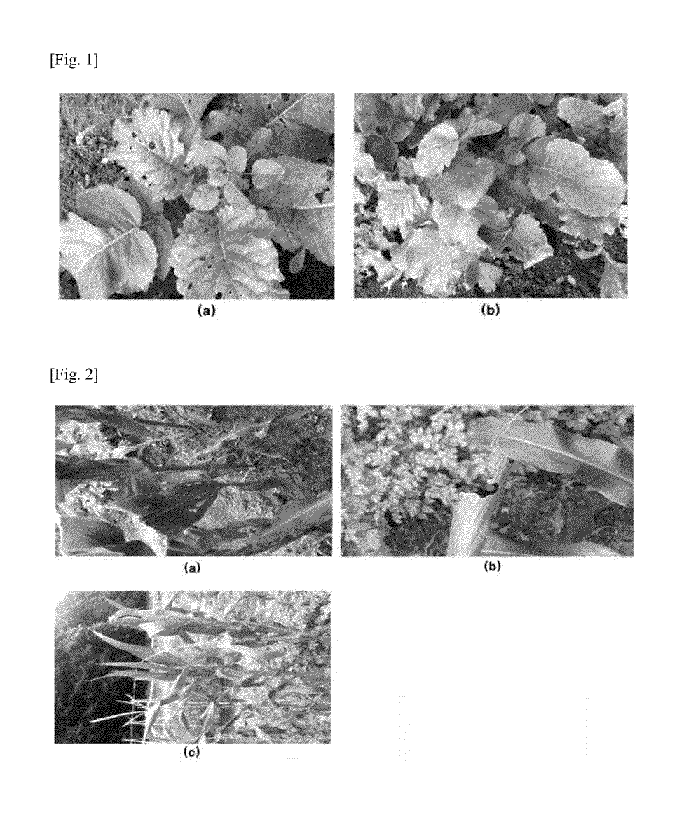

When the coffee grounds were sprayed on the leaves of young radishes as a fertilizer, it was found that the leaves of the young radishes were protected from pests, as shown in FIG. 1B. Meanwhile, the leaves of the young radishes on which the coffee grounds were not sprayed were damaged by pests, as shown in FIG. 1A.

(2) Experimental Example 2: Spraying of Solution of Coffee Grounds

A solution obtained by mixing coffee grounds with water and filtering out the coffee grounds was sprayed on maize.

The maize on which the solution of coffee grounds was sprayed was damaged less by pests 10 days after the spraying of the solution of coffee grounds, as shown in FIG. 2C.

(3) Experimental Example 3: Spraying of Unboiled Solution of Coffee Grounds

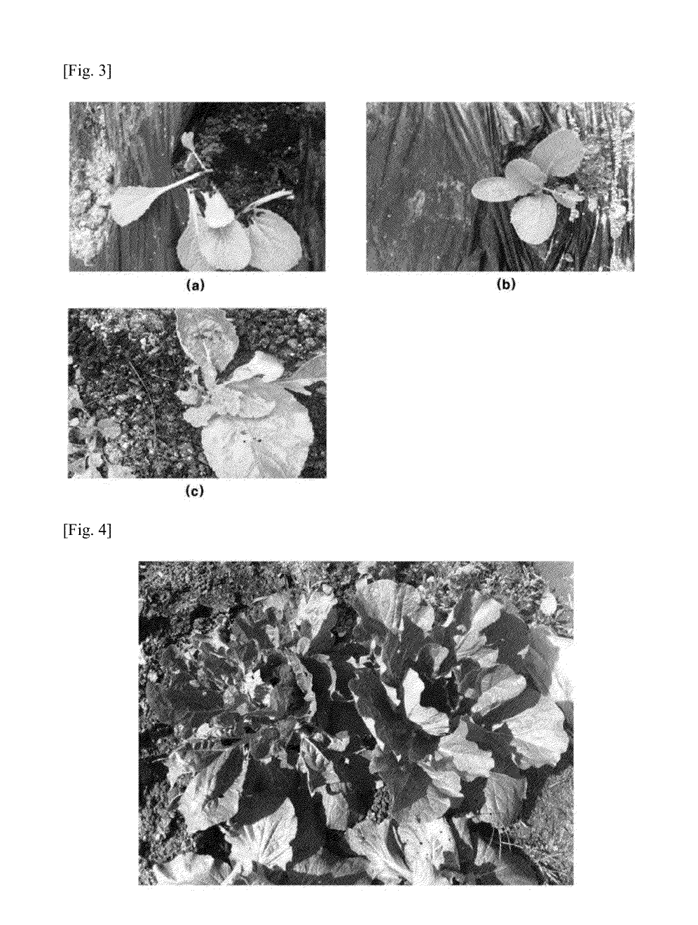

Sowed seedlings of Chinese cabbage were observed before and after an unboiled solution of coffee grounds was sprayed on the seedlings. After a week, some damage of some seedlings from mole crickets was able to be prevented, as shown in FIG. 3B, but the seedlings were vulnerable to diamondback moth larvae. Also, it was found that the medicinal effect did not last for a long period of time, and the unboiled solution of coffee grounds was washed away by rain.

(4) Experimental Example 4: Composition Including Boiled Extract of Coffee Grounds and Egg Yolk Oil

A composition prepared by mixing a boiled extract of coffee grounds with egg yolk oil was sprayed on seedlings of Chinese cabbage, lettuce, and white radishes. As a result, the pest repellent effect appeared in early stages, but did not last for more than a week.

(5) Experimental Example 5: Composition Including Boiled Extract of Coffee Grounds and Mayonnaise Mixed Solution

A composition prepared by mixing a boiled extract of coffee grounds with a mayonnaise mixed solution was sprayed on seedlings of Chinese cabbage, lettuce, and white radishes. As a result, the pest repellent effect appeared in early stages, but did not last for more than a week.

(6) Experimental Example 6: Composition Including Extract of Coffee Grounds and EM Activated Solution

A composition prepared by mixing an extract of coffee grounds with an EM activated solution was sprayed on seedlings of Chinese cabbage, lettuce, and white radishes. As a result, the pest repellent effect appeared in early stages, but did not last for more than a week.

As described above, the composition according to one exemplary embodiment of the present invention has an effect of preventing damage of plants from pests such as mole crickets, diamondback moth larvae, and the like since coffee oil constituents and tannin components extracted from the coffee grounds, egg yolk oil, and an EM mixture act in connection with the composition. Also, since the effects of the coffee grounds last for approximately one to two weeks after spraying the coffee grounds once, the coffee grounds need not be scattered around the plants often, and eco-friendly plants can grow without using ingredients of agricultural chemicals since the coffee grounds are harmless to the plants.

While the invention has been shown and described with reference to certain exemplary embodiments thereof, it will be understood by those skilled in the art that various changes in form and details may be made therein without departing from the scope of the invention as defined by the appended claims.

1. A pest control composition comprising an extract of coffee grounds, egg yolk oil and an effective microorganism (EM) activated solution as active ingredients.

2. The pest control composition of claim 1, wherein the extract of coffee grounds is present at a content of 85 to 95 parts by weight, based on a total of 100 parts by weight of the composition.

3. The pest control composition of claim 1, wherein the egg yolk oil is a mixture of egg yolk and vegetable oil, and is present at a content of 4 to 10 parts by weight, based on a total of 100 parts by weight of the composition.

4. The pest control composition of claim 1, wherein the EM activated solution is present at a content of 1 to 5 parts by weight, based on a total of 100 parts by weight of the composition.

5. The pest control composition of claim 1, wherein the pest is a mole cricket, or a diamondback moth larva.

6. A pest control composition comprising an extract of coffee grounds, a mayonnaise mixed solution and an EM activated solution as active ingredients.

7. A method for preparing a pest control composition, comprising:
(A) preparing an extract of coffee grounds by heating coffee grounds in boiling water for 5 minutes or more so that coffee oil is sufficiently extracted in the boiling water;
(B) diluting the extract of coffee grounds with water;
(C) preparing egg yolk oil by mixing egg yolk and edible oil; and
(D) mixing an EM activated solution with the extract of coffee grounds of Operation (A) and the egg yolk oil of Operation (C).

8. The pest control composition of claim 2, wherein the pest is a mole cricket, or a diamondback moth larva.

9. The pest control composition of claim 3, wherein the pest is a mole cricket, or a diamondback moth larva.

10. The pest control composition of claim 4, wherein the pest is a mole cricket, or a diamondback moth larva.
